(19) United States
(12) Patent Application Publication
(10) Pub. No.: US 2008/0309059 A1
(43) Pub. Date: Dec. 18, 2008

(54) VEHICLE TRACTION ENHANCEMENT SYSTEM

(76) Inventor: Aaron Clements, West Chester, OH (US)

Correspondence Address: WOOD, HERRON & EVANS, LLP, 2700 CAREW TOWER, 441 VINE STREET, CINCINNATI, OH, 45202, US

(21) Appl. No.: 11/763,577

(22) Filed: Jun. 15, 2007

(51) Int. Cl. B60S 9/22

(52) U.S. Cl. 280/759

(57) ABSTRACT

A vehicle traction enhancement system for use in a vehicle storage compartment such as a trunk or truck bed, to add weight or ballast above the driven wheels to improve traction, especially during times of inclement weather. The system includes an elongated carrier and retention devices or compartments for the weights.

### TECHNICAL FIELD

This invention relates generally to vehicle traction enhancing devices, particularly of the ballast weight type for a rear wheel drive vehicle.

### BACKGROUND

Ground vehicles, such as an automobile or a truck, are dependent upon good traction between their tires and the road upon which they are being driven. Traction is a function of the coefficient of friction between the tire and the road on which it travels, and the force (weight) pushing the tire into contact with the road. Maintaining high traction is desirable for control of the vehicle. Traction is maximized when the coefficient of friction and vehicle weight are both high.

Under normal driving conditions, a high coefficient of friction, readily available from the good tire and road materials that are commonly used, leads to satisfactory traction for any given vehicle weight. Since traction is normally satisfactory, vehicle designers try to minimize vehicle weight to achieve several benefits, including improved fuel economy. Throughout the history of automotive travel, vehicles have had to contend with weather conditions such as rain, snow, and ice that reduce the coefficient of friction between the tires and the road, thus making vehicle traction temporarily less than satisfactory. At these times, the often-employed method for enhancing traction is to temporarily increase the weight acting downward on the tires, by making the vehicle heavier. This increased weight is most desirable over the “driven wheels” that have the tires that must transmit the torque of the engine to the road surface.

In many automobiles, such as pickup trucks and rear wheel drive sedans, a storage compartment such as a trunk or a cargo bed sits near the driven wheels. Empty storage compartments such as these are among the lightest areas of the vehicle, so tires located near them have little weight forcing them into contact with the road. However, these compartments do provide an area to which weight, sometimes referred to as ballast, can be temporarily added. Some examples of readily available weights that have been temporarily added include snow, tree stumps, boulders, containers filled with sand or water, and large concrete blocks. These materials, and others, are often placed loosely in the storage compartments.

Drawbacks of these various materials can include difficulty in carrying them to and from the vehicle, storing them when not installed, securing them to prevent movement, and a low weight to volume ratio that causes the storage compartment to be too full to perform its primary function of carrying the goods for which it was intended.

Thus, a need exists for an easy to use high-density, aesthetically pleasing, modular vehicle traction enhancement system that can be installed and removed by people of limited lifting ability. The system should be optimized to consume a minimal amount of the available cargo space.

### SUMMARY

One embodiment of a vehicle traction enhancement system according to this invention includes an elongate carrier selectively coupled to a bed of a vehicle storage compartment. The system includes a plurality of retention devices spaced along a length of the carrier, and a plurality of weights each selectively retained by one of the retention devices on the carrier. The carrier and associated weights are positioned relative to the driven wheels of the vehicle to increase traction of the vehicle.

Other embodiments of this invention are directed to the system in combination with the vehicle and a method of enhancing vehicle traction.

The accompanying drawings, which are incorporated in and constitute a part of this specification, illustrate embodiments of the invention and, together with a general description of the invention given above, and the detailed description given below, serve to explain the principles of the invention.

### BRIEF DESCRIPTION OF THE FIGURES

FIG. 1 is a perspective view of an exemplary vehicle traction enhancement system installed in the bed of a rear wheel drive truck.

FIG. 2 is a view of part of the embodiment of FIG. 1, showing an open compartment receiving a weight, and the attachment between the truck bed and the belt.

FIG. 3 is a perspective view of the embodiment of FIG. 1 installed in an automotive sedan's trunk.

### DETAILED DESCRIPTION

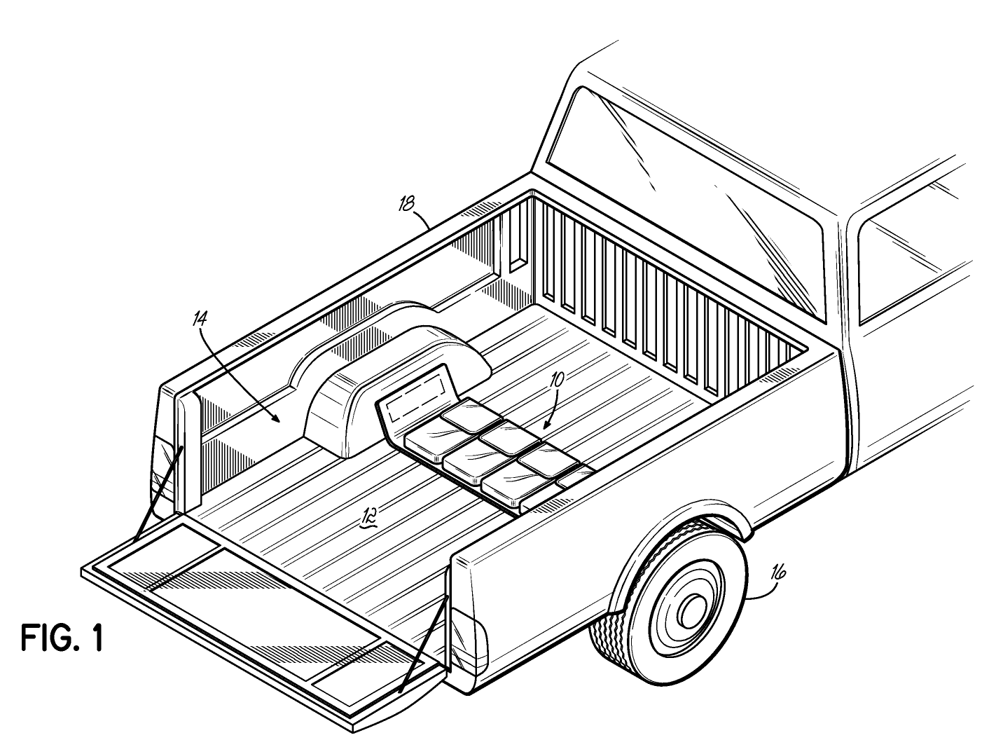

FIG. 1 depicts a vehicle traction enhancement system 10 in a bed 12 of a storage compartment 14 over the driven wheels 16 of a vehicle 18.

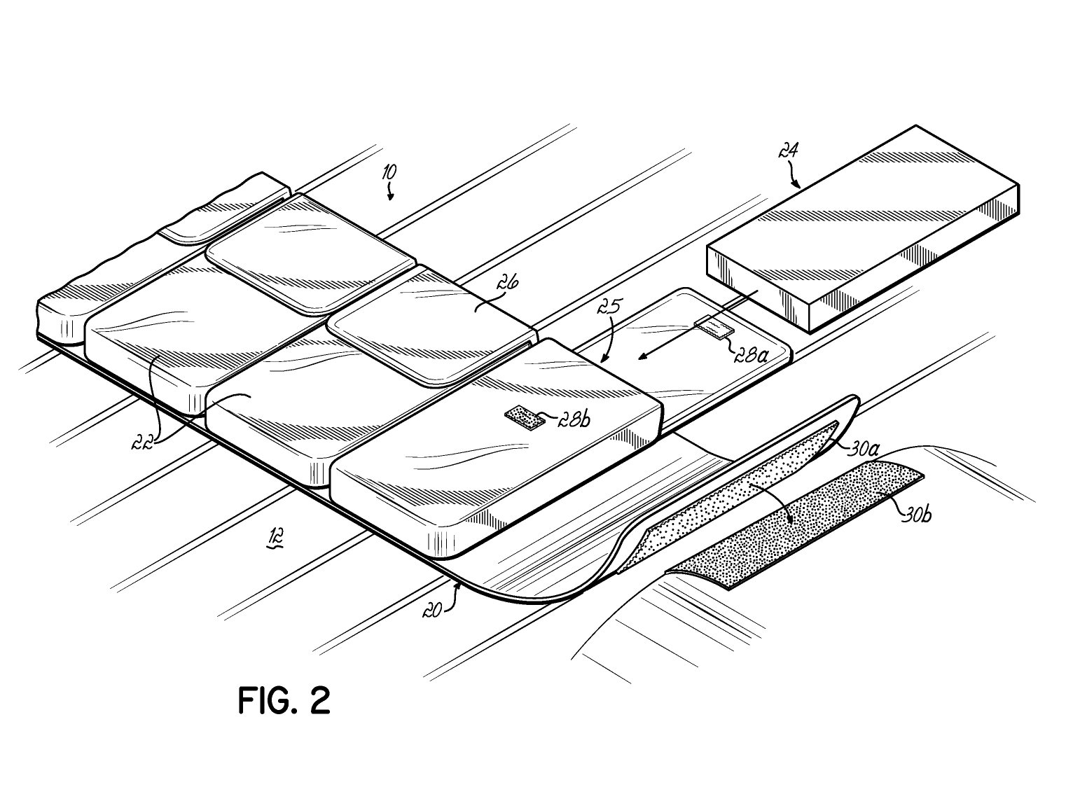

FIG. 2 depicts the traction enhancement system 10 that includes an elongate carrier 20 having compartments 22 that act as a retention device for weights 24. Weights 24 can be provided as a part of the system, or alternatively assimilated from readily available materials such as barbell weights or construction materials. Weights 24 are preferably of a size that is convenient for even a person of small stature and strength to individually carry and install, yet not so small that it would take an unreasonably large number of compartments and weights to achieve a significant weight gain. A weight of approximately 12 lbs would be an example of a preferred size for the individual weights, but larger or smaller compartments and weights could also be used. Each compartment 22 has a flap 26 acting as a closure mechanism. The flap 26 and the compartment 22 include mating hooks and loops fasteners such as Velcro™ portions 28a and 28b, although alternatively, other fastening systems well known in the art could be used.

To fasten the system 10 to the bed 12, a variety of methods could be used. In this embodiment, mating Velcro™ portions 30a and 30b are shown at one end of the carrier 20, and identical pieces are used on the other end (not shown). Carrier 20 has Velcro™ 30a attached to it by stitching or other methods, and bed 12 has Velcro™ 30b attached by an adhesive or another attaching process. Carrier 20 along with the Velcro™ portions 30a may be installed and removed as needed by mating the portions 30a and 30b together, either when the carrier is loaded with weights 24, or preferably when it is empty so that the person need not lift and work with such a heavy object. Other examples of fastening devices instead of Velcro™ could be nuts and bolts or hooks and eyes.

Optionally, an anti-skid material (not shown), such as textured rubber, could be used under the bottom of the carrier 20 to reduce the loads transmitted to the fastening device 30a and 30b while the vehicle changes speed or direction.

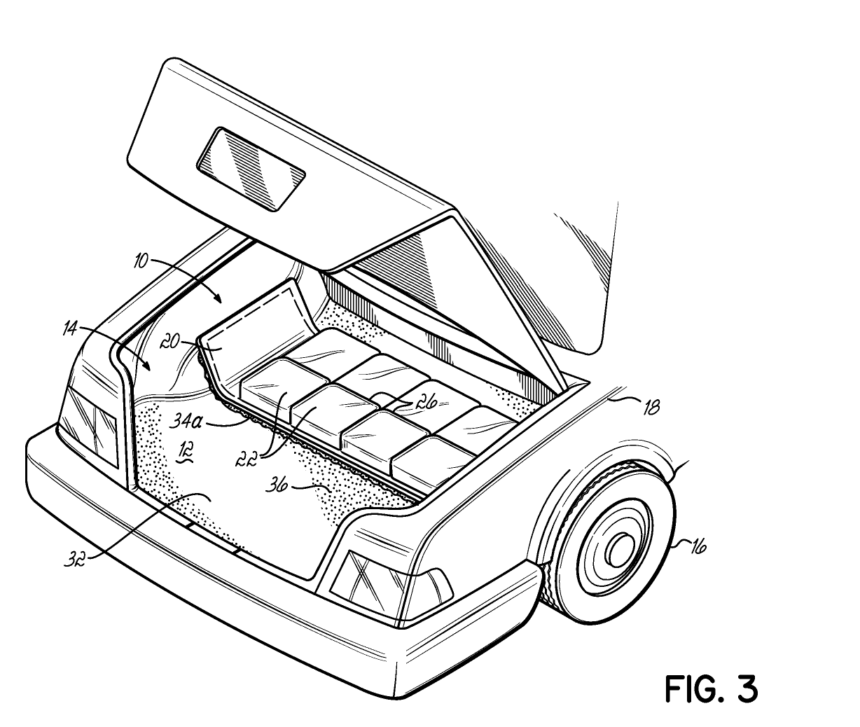

FIG. 3 is another embodiment of system 10, very similar to that installed in FIG. 2. In this embodiment the flaps 26 covering the opening 25 (not shown) of the compartments 22 are facing the opening 32 of storage compartment 14, which is in the rear of the vehicle 18. This rearward orientation of opening 25 is preferred so that a person standing at the opening 32 of the trunk and installing weights 24 into the compartments 22 extends their reach less than if the openings 25 were facing forward. This is ergonomically beneficial to the person loading and removing the weights. Carrier 20 has a Velcro™ hook portion 34a under its entire length. If the carpet 36 in the trunk is of a loop-like nature that will mate to the hook portion 34a, then the other portion of Velcro™ is not needed. Otherwise, a loop portion 34b (not shown) is used atop the carpet and under hook portion 34a.

While this invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. For example, the compartments 22 that are depicted in the preceding drawings include sides that are approximately perpendicular to their tops and bottoms. Other embodiments could have the compartment formed from only a top and a bottom material, with appropriate slackness to allow a weight to fit inside. Also, while each of the preceding drawings showed only one carrier 20 installed, the modular nature of the device includes the ability to install these side by side, anywhere they will fit in the storage compartment 14. The invention in its broader aspects is therefore not limited to the specific details, representative apparatus and method and illustrative examples shown and described. Accordingly, departures may be made from such details without departing from the general inventive concept.

What is claimed is:

1. A vehicle traction enhancement system comprising:
an elongate carrier selectively coupled to a bed of a vehicle storage compartment;
a plurality of retention devices spaced along a length of the carrier; and
a plurality of weights each selectively retained by one of the retention devices on the carrier, wherein the carrier and associated weights retained thereon by the respective retention devices are positioned relative to the driven wheels of the vehicle to increase traction of the vehicle relative to a road surface under the vehicle.

2. The system of claim 1, wherein the elongate carrier is non-rigid.

3. The system of claim 1, wherein each retention device further comprises a compartment attached to the carrier, each compartment including a closure mechanism to selectively close and open the compartment for retention and access, respectively, to one of the weights.

4. The system of claim 3 wherein the compartments and closures are integral with the carrier.

5. The system of claim 1, wherein each of the weights is selectively and individually removable from the carrier to facilitate transport of the system to and from the vehicle storage compartment.

6. The system of claim 1, further comprising:
an attachment mechanism on the carrier to selectively secure the carrier relative to the bed of the vehicle storage compartment.

7. The system of claim 1 further comprising an antiskid material along the bottom of the elongate carrier.

8. A combination comprising:
a vehicle having at least one driven wheel;
a storage compartment in the vehicle proximate the driven wheel, the storage compartment having a bed;
an elongate carrier selectively coupled to the bed of the vehicle storage compartment;
a plurality of retention devices spaced along a length of the carrier; and
a plurality of weights each selectively retained by one of the retention devices on the carrier, wherein the carrier and associated weights retained thereon by the respective retention devices are positioned relative to the driven wheel of the vehicle to increase traction of the vehicle relative to a road surface under the vehicle.

9. A method for enhancing vehicle traction in a rear wheel drive vehicle comprising:
installing a carrier in a bed of said vehicle, the carrier having a plurality of compartments;
selectively opening the compartments and inserting weights; and
closing the compartments to retain the weights.

10. The method of claim 9 further comprising:
selectively opening the compartments; and
individually removing and transporting the weights to facilitate the removal of the carrier and weights from the bed.

11. The method of claim 9, wherein the installing step further comprises affixing an attachment mechanism to the bed, and attaching the carrier to the attachment mechanism.
